(19) United States
(12) Patent Application Publication
(10) Pub. No.: US 2010/0287493 A1
(43) Pub. Date: Nov. 11, 2010

(54) METHOD AND SYSTEM FOR VIEWING AND EDITING AN IMAGE IN A MAGNIFIED VIEW

(75) Inventors: Chayan Majumder, Delhi (IN); Donald J. O'Riordan, Sunnyvale, CA (US)

Correspondence Address: Cadence Design Systems, Inc.;c/o Sawyer Law Group, P.C., P.O. Box 51418, Palo Alto, CA, 94303, US

(73) Assignee: CADENCE DESIGN SYSTEMS, INC., San Jose, CA (US)

(21) Appl. No.: 12/436,747

(22) Filed: May 6, 2009

(51) Int. Cl. G06F 3/048; G09G 5/00

(52) U.S. Cl. 715/788; 345/661

(57) ABSTRACT

Viewing and editing of a displayed image in a magnified view. In one aspect, a method for displaying a magnified image using a computer system includes causing a display on a display device of a first image, and causing a display on the display device of a second image that is a portion of the first image. The second image has a zoomed-in view that is a closer view of the portion than in the first image. At least one edit is caused to the second image in response to at least one input received at the second image.

### FIELD OF THE INVENTION

The present invention relates to graphical display by computer systems, and more particularly to viewing and editing graphical images using a computer system.

### BACKGROUND OF THE INVENTION

Computer-enabled graphical editing systems are used in a wide variety of different applications and industries to view and edit different types of visual images on computer systems or other electronic devices. One common application is electronic design automation, including such applications as layout design, in which the designs for components and spatial layout of electronic components such as integrated circuits and circuit boards are viewed, created and edited using displayed images.

Layout designers use graphical editing software to create and edit layout designs. One of the common features of most editing applications is a zoom function, in which the user can view a subject image at various different magnification levels. During the inspection and/or editing of a design, designers commonly spend much of the time zooming the view of components in or out, i.e., to get a closer view of the components for more detailed and precise viewing and editing, and to get a further-out view of the components for an overall view or to be able to select a different portion of the view for closer inspection.

Zoom operations, however, are often burdensome for designers. For example, in one benchmark study, experienced designers having a high design speed used zooming operations on average of 4-6 times per every 10 seconds during a focused layout editing task. This count averaged even higher, at 7 or greater zooming operations per 10 seconds, when the designer was analyzing a design, e.g., for planning a task or inspecting a constructed design. Such numerous zoom operations take time and intensive attention of designers. Furthermore, the zoom operations often cause a designer to lose track of particular locations and areas on a design canvas due to the required zoom operations, which can be disorienting when moving between different levels of view. Thus, such required numerous zoom operations greatly reduce the productivity of designers creating and editing layout designs. Graphical editing systems for other applications also commonly require a large and burdensome number of zoom operations to view and edit features in an image.

### SUMMARY OF THE INVENTION

The inventions of the present application relate to graphical viewing and editing of a displayed image. In one aspect of the invention, a method for displaying a magnified image using a computer system includes causing a display on a display device of a first image, and causing a display on the display device of a second image that is a portion of the first image. The second image has a zoomed-in view that is a closer view of the portion than in the first image. The method causes at least one edit to the second image in response to at least one input received at the second image. A similar aspect is provided for a computer program product comprising a computer readable medium including program instructions for implementing similar features.

In another aspect, a system for displaying a magnified image using a computer system includes a memory, and a processor in communication with the memory. The processor causing a display on a display device of a first image, and causes a display on the display device of a magnifier window including second image that is a portion of the first image. The second image has a zoomed-in view that is a closer view of the portion than the displayed view of the first image. The processor also causes at least one edit to the second image in response to at least one input received at the second image.

The present inventions allow a user to work within a graphical interface to design and edit an image and significantly reduces the number of zoom operations required to perform viewing and editing tasks. An editable magnifier view permits the user to maintain a high-level view of an image at the same time as using a lower-level, detailed view for use with accurate viewing and editing of portions of the displayed image, thereby allowing the user to plan and execute viewing and editing tasks with greater ease.

### BRIEF DESCRIPTION OF THE FIGURES

FIG. 1 is a block diagram illustrating a system suitable for use with the present invention;

FIG. 2 is a diagrammatic illustration of an example embodiment for use with the present invention, including a graphical interface and displayed image;

FIG. 3 is a diagrammatic illustration of the interface of FIG. 2 in which an editable magnifier of the present inventions is displayed;

FIG.4 is a diagrammatic illustration of another embodiment of an interface in which a magnifier window having a circular shape is displayed;

FIG. 5 is a diagrammatic illustration of a portion of the image and the magnifier window embodiment of FIG. 3; and

FIG. 6 is a flow diagram illustrating an example of a method of the present inventions for providing a magnifier window.

### DETAILED DESCRIPTION

The present inventions relate to graphical display by computer systems, and more particularly to viewing and editing graphical images using a computer system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of particular methods and systems provided in particular implementations. However, one of ordinary skill in the art will readily recognize that these methods and systems will operate effectively in other implementations. For example, the system implementations usable with the present invention can take a number of different forms. The present invention will also be described in the context of particular methods having certain steps. However, the method and system operate effectively for other methods having different and/or additional steps not inconsistent with the present invention.

The inventions herein can take the form of a software embodiment, a hardware embodiment, or an embodiment containing both hardware and software elements. A software embodiment can include but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk read only memory (CD-ROM), compact disk read/write (CD-R/W) and DVD.

The present inventions allow accurate editing capability while in a zoomed-out (“high altitude”) view of an image by allowing users to plan and manipulate features of the view from a high level or “altitude”, and also allows the flexibility to “zoom-dive” into a particular portion or area of the image to provide a zoomed-in view of that area, allow localized viewing and edits at that area. The user can also return to the exact same high altitude view as previously used. The present invention provides the equivalent of an “on-demand magnifying glass” for a displayed image, where the contents of the magnifying glass are editable as in the main displayed view.

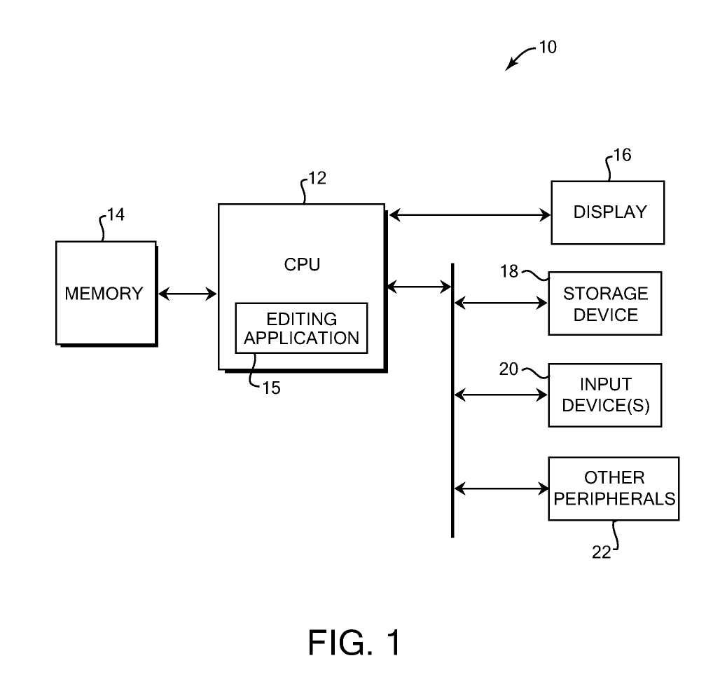

To more particularly describe the features of the present invention, please refer to FIGS. 1-6 in conjunction with the discussion below.

FIG. 1 is a block diagram illustrating a system 10 suitable for use with the present invention. System 10 can be any suitable computer system, server, or other electronic or hardware device. For example, the system 10 can be a mainframe computer, desktop computer, workstation, portable computer, or electronic device (set-top box, portable device, cell phone, personal digital assistant, media player, game device, etc.). System 10 includes a CPU 12, memory 14, display device 16, storage device 20, input device(s) 22, and other peripherals 24.

CPU 12 can be one or more microprocessors or other processors to execute program code and control basic operations of the system 10, including processing operations, manipulating data, issuing commands to other components of the system 10, etc. For example, an operating system can run on the system 10 and is implemented by the microprocessor 20 and other components of the system 10. CPU 12 can also implement graphical editing software 15 of the present invention, as described further below.

Memory 14 is typically provided in system 10 for access by the CPU 12, and can include one or more of a variety of types, such as random access memory (RAM), read-only memory (ROM), Electrical Erasable Read-only Memory (EEPROM), Flash memory, etc.

Display device 16 outputs displayed images to a user of the system 10. Display device 16 can be any of a variety of types of displays, including LCD, Plasma, CRT, etc. Some implementations of the display device 16 include a screen having a screen size, e.g., an area within which images are displayed. Storage device 18 can store data that may be retrieved by the CPU (including program instructions and/or data for graphical editing software 15), and can be any of a variety of devices such as a hard disk, CD-ROM, DVD-ROM, Blu-Ray disc, magnetic tape, etc. Input devices 22 can include any of a variety of devices that allow users to input commands and data to the CPU, including a keyboard, mouse, trackball, stylus, touchscreen, microphone/voice recognition device, motion sensors, other electronic device (such as another computer system or portable electronic device), or other input device. Other peripherals 24 can include any other devices connected to and used by the system 10, such as any peripheral, card, or interface device that performs one or more functions and communicates with the system 10, such as network adapters that enable the system 10 to become coupled to other computer systems or devices through intervening private or public networks, scanners, printers, sensors, speakers, etc. In the example of FIG. 1, the display device 16 is connected to the CPU 12 by its own dedicated bus, while storage device 20, input devices 22, and other peripherals 24 are connected to a common bus that is also connected to the CPU. In other embodiments, the display device 16 and other devices can each have their own bus, or share one or more common buses. One or more of the buses or other links can be implemented using wires or wirelessly, according to any of well known standards and protocols.

The graphical editing application 15 and interface of the present inventions can be implemented by the CPU 12 to display one or more images and/or interface on the display device 16 and receive input from one or more of the input devices 22 to control the functions of the application and interface. The software 15 can also be stored on storage device 20 and/or in memory 14. The functionality of software 15 is described in greater detail below.

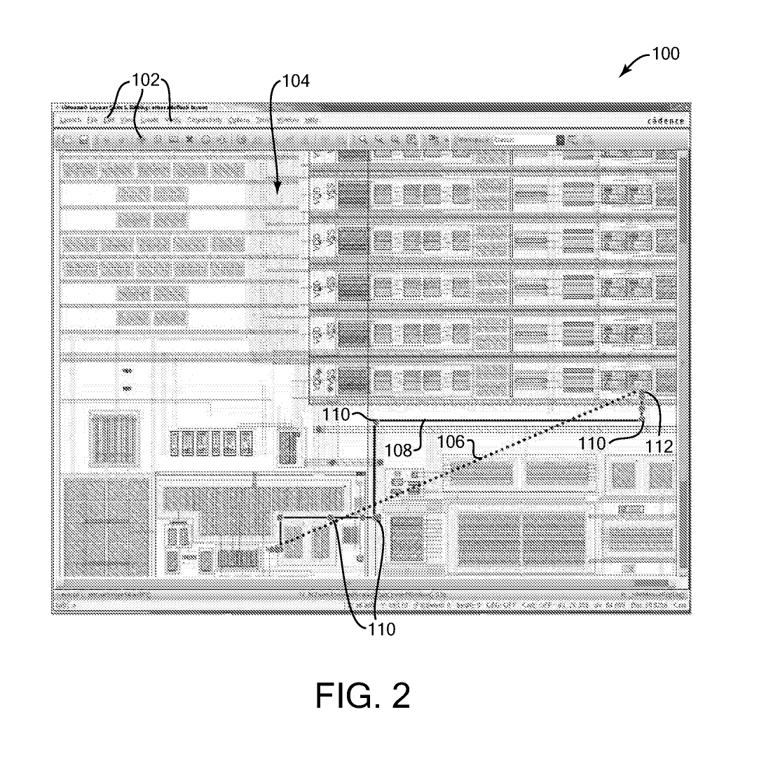

FIG. 2 is a diagrammatic illustration of illustrating an example embodiment 100 of a viewing and editing graphical interface for a viewing and editing application for use with the present invention, including a displayed interface and image. The interface is shown as a displayed window within a graphical user interface, but can be displayed in other forms in other interfaces. In the displayed interface 100, various controls 102 are displayed such as menu items and buttons which allow the user to select various viewing and editing functions of the application and interface 100. The interface 100 also displays a main image 104 which is created and/or edited by the user with functions of the interface 100. The image 104 displayed in the interface 100 can be part of a complete, larger image (or complete set of data of interest to the user) that is stored in the memory 14 or other data storage of the system 10, where only part of the complete image is displayed in the interface 100 at one time. Alternatively, or at other zoom levels, the image 104 can be the complete image.

In the example embodiment shown, a layout design application is being used on system 10 and provides the interface 100. This application allows designers to create and edit layouts for integrated circuits, circuit boards, or other electronic designs (and may have many other functions, not detailed here). For example, the layout design application of interface 100 displays an image 104 which can be the entire “canvas” for the layout design, or only a part of the canvas, and which depicts an integrated circuit layout having transistors, electrical traces, vias for connecting different layers, and other electronic components. The user can create, add, delete, or modify the component images in the image 104, which in some embodiments can modify a data model of these components that corresponds to the displayed images.

In the example of FIG. 2, a user has routed an electrical trace between two locations in the displayed layout image 104, where the desired connection is shown as dotted line 106. To implement this connection, the user examines the layout image and determines the best path between the two desired connection points. In this example, the user has created a route or trace 108 along a path determined to satisfy the requirements of the circuit and the connection. The user has also created several vias or contacts 110 at several points along the trace 108. The interface 100 and editing application provide well-known viewing and editing functions to allow the user to create and edit the components and layout of the layout image 104. Other embodiments may allow varying degrees of automation in the planning and/or layout tasks.

One of the viewing functions allowed by the editing interface 100 is a standard zoom function, which allows the user to zoom the view of the image 104 in and out, i.e. to lower levels and to higher levels. For example, when using the standard zoom function, the user can select a zoom function from the menus and/buttons 102, and/or from an input device such as a particular key or key combination on a keyboard or a mouse button. When a standard zoom-in function is selected, the entire image 104 is displayed at a lower level, i.e., zoomed in so that the details of the image 104 are displayed larger. After a sufficient degree of zoom-in, only part of the complete image is displayed in the interface 100 as image 104. The zooming in allows the user to view features of the image that may not have been visible from a higher level, and/or add or edit details in the image more accurately and precisely. However, the zoomed-in view has the tradeoff that less of the image 104 is displayed in the interface 104, and so the user must zoom out to view or edit features larger than the zoomed-in view displays. In addition, the user can get more disoriented as to what location is being viewed at the zoomed-in level. Similarly, the user can select a zoom-out function to view a larger part of the image 104 in the interface (or the complete image or canvas, at different distances), but this has the tradeoff that less detail can be seen and image features can be edited less accurately and precisely.

To create features such as the trace 108 and vias 110 of layout image 104, a large number of standard zoom operations (i.e., the activation of a zoom function to cause the image 104 to be zoomed in or out) are typically required. For example, to first plan the path, approximately 20 zoom operations may be needed, because the user would zoom in, check out the possible routes and intersections in one location, zoom out, move to other location to check the possible routes, and so on. Furthermore, when starting to create the route, five or so zoom operations may be needed to find the correct zoomed-in level to drop a contact at a starting location 112. This is because the user needs to find a comfortable zoomed-in level at which to work, which may take a number of zoom-in operations; furthermore, the desired location may not be centered in the view after a zoom operation, which may require more zoom-out operations, scrolling of the image, and zoom-in operations. Then the user must provide a number of further zoom-out operations to return to a higher-level view that allows the user to move or continue a trace 108 from the starting location 112 to other locations on the displayed layout. Additional, similar zoom operations are required for the user to continue the trace 108 and drop vias 110. Such a large number of zoom operations can quickly become unwieldy and tedious, leading to a large loss in productivity due to excessive and intensive time spent commanding the zoom operations and finding a desired viewing level during the planning, creation, and editing of layout features.

An interface 100 of the present inventions can include an editable magnifier that can significantly decrease the number of zoom operations needed from a user to perform layout design or other image manipulation. The performance and functionality of the editable magnifier is described in greater detail below.

In other embodiments, other types of images can be displayed in interface 100 for other applications instead of layout design. For example, line drawings, graphical objects, photo images, maps, or other images can be displayed, created and/or edited similarly to the layout image 104 described above. Such other embodiments and applications also may use a large number of zoom operations and thus can also benefit from the present inventions.

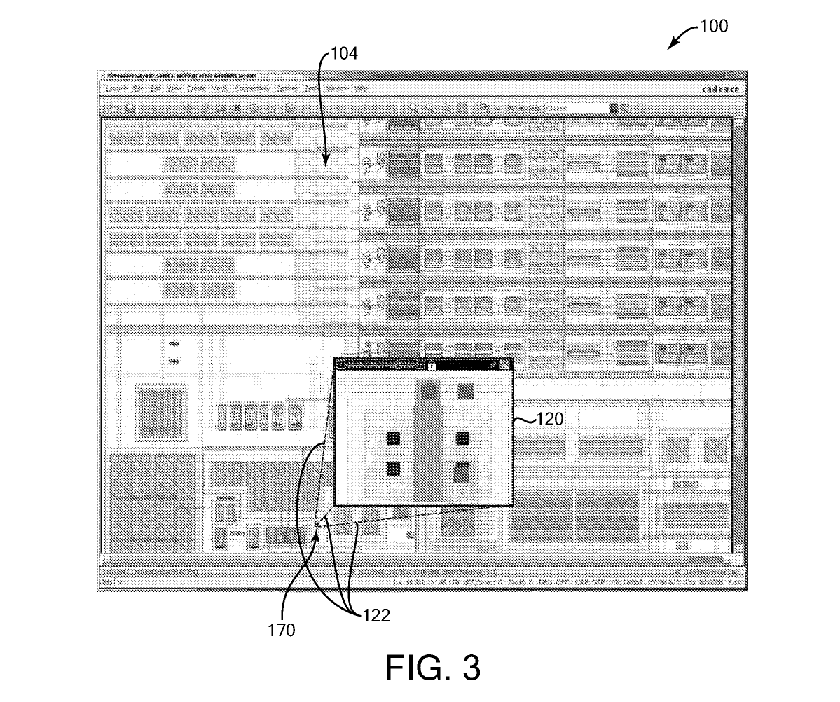

FIG. 3 is a diagrammatic illustration of interface 100 of FIG. 2, in which an editable magnifier of the present invention has been selected and is displayed. The editable magnifier, like the interface 100 and editing application, can be implemented by program instructions implemented by the system 10.

The editable magnifier can be invoked in any of several different ways in different embodiments. For example, in various embodiments a user can select a menu item, select a displayed button, press a key, key combination, button, or other input selection device on an input device or peripheral, input a voice command, or provide the invoke command as input in another way. In other embodiments, the command to invoke the editable magnifier can be received by the interface 100 or editing application from a user, another device, or other source.

In some embodiments, a user can also select a location or portion 170 of image 104 which he or she wants to be displayed in the new magnifier window 120. For example, the user might select an invoke-magnifier command as explained above, and then click on a portion 170 of the image 104 (or drag a selection box to enclose a desired portion/area 170) which the user wishes to be displayed in the window 120. The selected location 170 can be positioned in the middle of the displayed window 120. Or the user can select the desired location 170 with a particular selection, command or button which also acts as an invocation command, such as clicking on a location of image 104 using a specialized mouse button. In one example, the user can select the desired location 170 with a pointer or cursor, while holding down a command key or button which is associated with invoking the magnifier window. In other embodiments, no user selection of a location of image 104 is input, and the magnifier window 120 can display a default portion of image 104, such as the center of the current image 104 as displayed in the interface 100.

In response to receiving the command to invoke the magnifier (and any other needed inputs as required by a specific embodiment, such as a selected location of image 104), the present invention causes a magnifier window 120 to be displayed on a display device 16. The magnifier window 120 displays a view of a particular portion or area 170 of the image 104 currently being displayed in the interface 100. Typically, the magnifier window 120 will display a closer, higher-magnification, zoomed-in (lower-level) view of the area 170 of the image 104. The magnifier window 120 is set to a predefined size (user-selectable in some embodiments). In the described embodiment, the size of window 120 can be smaller than the image 104 to allow convenience of use and multiple windows 120 to be displayed. In other embodiments, the magnifier window 120 can be close to or the same size as, or larger than the image 104, or can be resized as the user desires. In some embodiments, the image 104 can be automatically resized to fit both image 104 and window 120 on the screen side by side or at other locations, at equal or predefined or user-defined sizes. Generally, it also should be appreciated that the embodiments of the present invention enable the magnifier window 120 and a less-magnified view of the particular portion or area 170 (e.g., a view that is unmagnified, or less magnified/higher level than the view in the window 120) to both be displayed within a predefined viewing area on the display device 16, in which the predefined viewing area is usually bounded by the screen size of a display screen of the display device 16.

In the example embodiment shown in FIG. 3, the magnifier window 120 is set as a default setting to be displayed slightly displaced towards the right and above the corresponding portion 170 of image 104 being shown, or selected to be shown, in the window 120. In many cases, this will cause the magnifying window 120 to at least partially overlap the image 104. This location provides a good sense of context for a user as to what area 170 of the image 104 is being displayed in the window 120. If there is no display space for the window 120 at this location, the window 120 can be adjusted in position until there is sufficient space. Other embodiments can display the window 120 at other locations, overlapping image 104 or not. The window 120 also can be moved, dragged, and/or re-positioned by the user or other input if desired. For example, the user can move a cursor onto the window 120, hold a button of an input device, and drag the window to another location using input commands such as movement of a mouse or other pointing device. In some embodiments, the magnifier window can be stationed at a certain location with location lines connecting the magnifier window and the specific area 170 being magnified, as described in greater detail below.

In the embodiment shown, the magnifier window 120 is opaque, such that no part of the image 104 can be seen behind the window 120. In other embodiments, the window 120 can be provided with a selective transparency that would allow a user-selected amount of the image 104 to be displayed behind or in the window 120. For example, the user can set a particular amount of transparency that may allow darker, more intense, or larger features of the image 104 to be seen though the window 120, which may give the user additional useful contextual information in some embodiments. In other embodiments, the magnifier window 120 can be displayed outside the image 104 so that no part of window 120 overlaps image 104.

In some embodiments, the magnifier window 120 can be displayed such that location lines 122 are displayed between the portion 170 of image 104 being shown in the window 120, and the window 120. These are shown as dotted construction lines in the example of FIG. 3, but can be displayed as solid lines or other indicators in other embodiments. The lines 122 more clearly and intuitively indicate to the user exactly which area 170 of image 104 is being shown in the magnifier window 120. The lines 122 can be moved to follow the window 120 if the window 120 is moved relative to the image 104.

The magnifier window 120 is shown as a rectangle in the example of FIG. 3, but can be displayed in any shape, such as circular, oval, polygon, irregular, user-defined, etc.

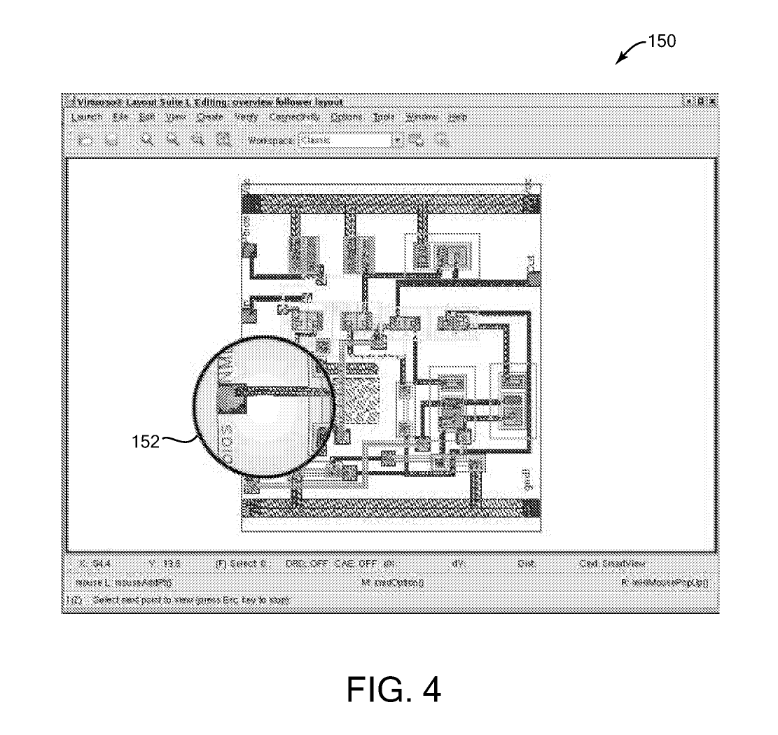

For example, FIG. 4 is a diagrammatic illustration of another embodiment of an interface 150 in which a magnifier window 152 is displayed, the window 152 having a circular shape. Furthermore, in some embodiments like that shown in FIG. 4, a “magnification effect” can be displayed, in which the image portion displayed in the window 152 is slightly bent or curved near the inside perimeter of the window as if the portion were being displayed in a physical magnifying glass.

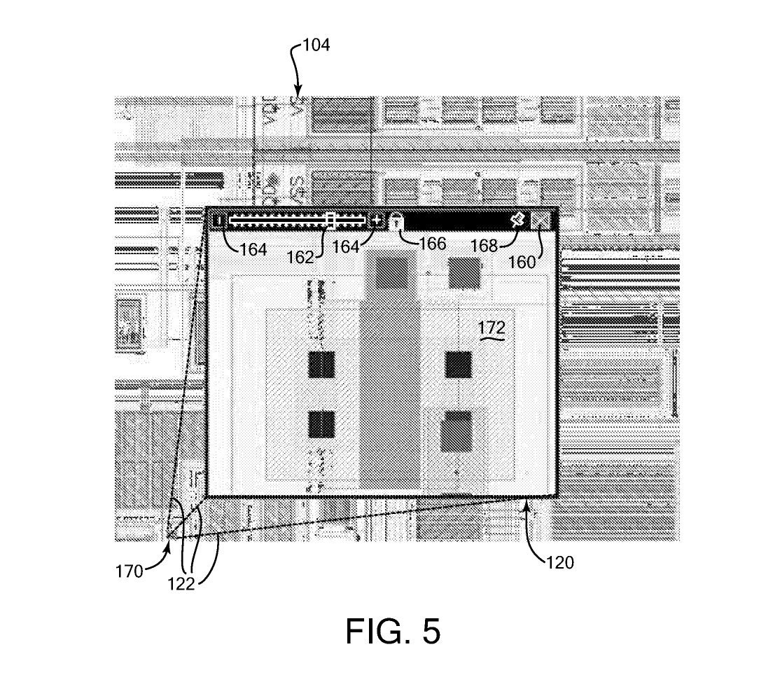

FIG. 5 is a diagrammatic illustration of a portion of the image 104 and the magnifier window 120 embodiment of FIG. 3. An advantage of the magnifier window 120 is that it allows edits and changes to be made to the portion 170 of the image 104, and in appropriate embodiments allows corresponding changes to be made to any underlying model or data corresponding to or depicted by the image 104, such as an electronic layout model. The view 172 displayed in the window 120 is the magnified version of image portion 170, and edits made to the view 172 are made to the image 170 and any underlying model or data. Thus, for example, a user can move a displayed cursor or pointer within the window 120 and select, change, add, or delete features displayed or accessed in that window, such as objects, areas, shapes, colors, sizes, patterns, brightness, contrast, or any other image characteristics or attributes that are normally editable in the main image 104 as allowed by the interface 100 and editing application. In some embodiments, all the editing commands available in the interface 100 for the main image 104 are available to be used on the image portion 170 displayed within the magnifier window 120, including commands, bound hot keys and mouse buttons, mouse and keyboard functions, right mouse button menus, panning modes, etc. This allows a user to not only view and plan changes to an image in the magnifier, but also to make those changes directly in the zoomed-in view, thus avoiding numerous zoom operations to change the view of the main image to the desired lower level, edit the image portion 170, and zoom back out to the higher level. In some embodiments, some standard menus and selections, when invoked within window 120, can have additional options only applicable to the magnifier window 120. For example, a selection of “magnifier window properties” can appear in a right-mouse-button menu invoked when the mouse pointer is inside window 120.

In some embodiments, the magnifier window 120 can be removed from the display when the user makes a selection outside the window 120, e.g., clicks a mouse button when the mouse pointer is displayed outside the window 120. In some embodiments, the window 120 can alternatively or additionally be removed from the display when the user selects a “close” button 160 provided at the corner or other location in the window 120, or a close command is otherwise input. The window 120 also in some embodiments can be resized using the standard methods for resizing windows in a graphical user interface.

Multiple magnifier windows 120 can be displayed by the interface 100. Each magnifier window 120 can display a different zoomed-in view (like view 172) of a different portion (like portion 170) of the image 104. This allows a user to efficiently edit many different areas of an image 104 without having to perform zoom operations at each of those areas in turn or back and forth as different edits at different locations are made. In some embodiments, multiple images 104 can be displayed, and each image 104 can have its own set of multiple magnifier windows 120. Some embodiments can allow nested magnifier windows 120, i.e., a magnifier window displayed within a magnifier window 120, while other embodiments can prohibit such nested windows as creating too much displayed clutter. Some embodiments can allow a user to copy or drag objects or features displayed in one window 120 to another window 120, and/or allow all editing and copying functions between two or more magnifier windows. Also, in some embodiments, window 120 selections can include an option to close all displayed magnifier windows.

In some embodiments, the magnification factor of the view of the image portion displayed in the magnifier window 120 can be user-controllable. For example, a magnification slider or bar 162 can be displayed in the window 120. The user can select the slider with a cursor and slide it left or right to decrease or increase, respectively, the magnification factor of the view 172 of the image portion 170 shown in the magnifier window 120, thereby altering how large an area of the image 104 is displayed in window 120. Alternatively, the user can click on the “+” or “−” buttons 164 to increase or decrease the magnification factor. If one of the buttons 164 is selected continuously, the increase or decrease is also continuous. In some embodiments, the magnification factor of the view in window 120 can be based on the current magnification factor of the main image 104 shown in the interface 100. For example, the magnification factor of window 120 can be initially at a default level of X greater than the magnification factor of the image 104, where X is a number predetermined and/or user-defined. In another embodiment, if the current magnification factor of image 104 is 1 (at its furthest zoom level from the image, in this example), then a magnification factor of 10 in window 120 may result in the zoom level of window 120 shown in FIG. 5, while if the current magnification factor of image 104 is at 2 (twice as close to the image), then a magnification factor of 5 in window 120 can result in the shown zoom level. In other embodiments, the magnification factor in window 120 can be an absolute factor, independent of the current zoom level of image 104. This magnification slider allows users, who often work at different magnification levels, to avoid having to open a magnification menu in interface 100 multiple times and provides an easy way to adjust the zoom level in a case-by-case basis, also providing an instant preview.

The magnifier window 120 also can include a lock function in some embodiments, which locks the magnification factor of the window 120. When this function is in an “unlocked” state, the magnification factor applicable to a specific magnifier window 120 is applicable only to that window 120. If this function is set to a “locked” state, then all magnifier windows 120 displayed for the image 104, whether currently displayed or opened in the future, will be set to and operate at the same magnification level as the magnifier window 120 in which the lock function was selected. Thus if a user finds a particular magnification level at which he or she comfortably works, all future magnifier windows can be locked to this same desired magnification. In the example shown in FIG. 5, the lock function can be indicated by a padlock symbol 166, where the locked state is indicated by a closed lock symbol and the unlocked state is indicated by an open lock symbol.

The magnifier window 120 can also include a “pin” function in some embodiments, which can cause the magnifier window 120 to stay in its displayed location. Thus, if the window is in an unpinned state (not in the pinned state), the window 120 can be moved around or closed as described above. When the pinned state is selected to be active, the window 120 “sticks” to its current location in the interface 100 (such as on the image 104), cannot be moved by the user, and cannot be closed or removed from the display (until unpinned). This function can help prevent accidental or unwanted removal of the window 120 if, for example, the user mistakenly selects outside the window 120, and also allows multiple magnifier windows 120 to be manipulated more easily. In the example shown in FIG. 5, the pin function can be indicated by a pin symbol 168, where the pinned state is indicated as a displayed circle (overhead view of a pin) and the unpinned state is indicated as a side view of the pin, as in FIG. 5.

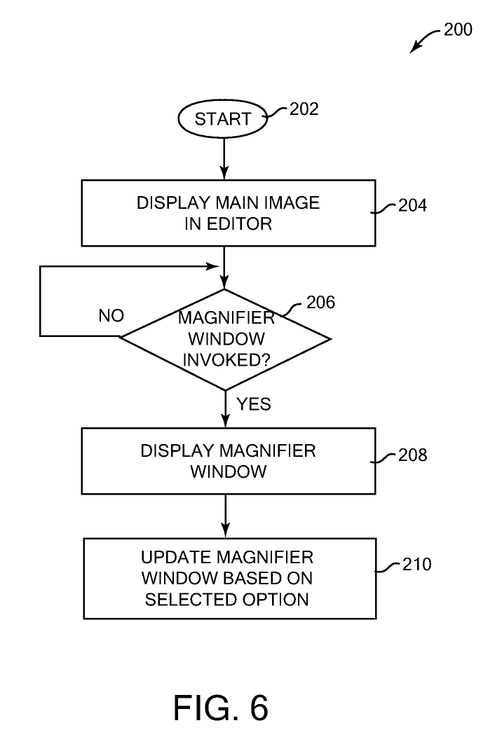

FIG. 6 is a flow diagram illustrating one example of a method 200 of the present invention for providing a magnifier window. Method 200 can be implemented, for example, by the components in system 10. Method 200 can be implemented by program instructions or code, which can be stored on a computer readable medium. Alternatively, the method 200 can be implemented in hardware (logic gates, etc.), or in a combination of hardware and software.

The method begins at 202, and in step 204, the main image 104 is displayed by the editor application run by system 10. As described above, image 104 can be a complete image or part of a complete image or canvas, depending on the zoom level of the editor application. In step 206, it is checked whether a magnifier window 120 has been invoked. As indicated above, the magnifier window can be invoked with any of many possible inputs or commands. If the magnifier window has not been invoked, the system 10 and editor application continue their standard operation and method 200 returns to step 206 to continue checked for magnifier window invocation.

If the magnifier window 120 has been invoked at step 206, then the method continues to step 208, in which the magnifier window 120 is displayed as described in any of the embodiments above. In step 210, the magnifier window is updated based on one or more selected options for the magnifier window (if any), as described above. For example, the magnification factor of the window 120 can be changed, the window 120 can be pinned or locked, or the window 120 can be closed. The window 120 can be updated with additional selections, as appropriate. Additional or other magnifier windows 120 can be invoked in a similar fashion.

The magnifier window of the present inventions provides many advantages to a user viewing and manipulating an image in an editing interface. The number of required zoom operations is significantly reduced, allowing an increase in productivity and efficiency in image design and editing. Providing all the normal editing capabilities inside the magnifier window allows full functionality for a designer for greater efficiency. Furthermore, users can work from a high zoom level and plan the design, can use the editable magnifier to view and edit the design at a detailed level when needed, and then can instantly return to the top level for more viewing or planning by simply viewing the image 104 and optionally by closing the window 120. Thus, both high-level and low-level viewing and editing are provided in one interface and model. In addition, the incorporation of both high and low-level viewing allows the user to avoid confusion and “getting lost” during abrupt zoom operations to different zoom levels as required by prior interfaces, and thus the user can avoid the additional zoom operations needed to re-orient oneself with a spatial context.

For example, in the example of a layout design, creating and editing parts of the design become easy when using the editable magnifier. When creating a circuit route, the designer can stay at a high zoom level all through the planning and execution of the route creation task while retaining the ability to dive into certain areas for precise editing. All of this is possible without the user losing any context due to extensive zoom operations. The high-level view lets the designer plan and see all the touch-down points of the canvas so that none are missed by mistake, and to easily determine which features need editing. The low-level, magnifier view allows the designer to accurate see and perform the required low-level tasks, such as editing characteristics of components, placing vias or contacts, maneuvering through congested areas, etc.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for displaying a magnified image using a computer system, the method comprising:
causing a display on a display device of a first image;
causing a display on the display device of a second image that is a portion of the first image, the second image having a zoomed-in view that is a closer view of the portion than in the first image; and
causing at least one edit to the second image in response to at least one input received at the second image.

2. The method of claim 1 wherein the second image is displayed in a magnifier window.

3. The method of claim 2 wherein the magnifier window and the first image are both displayed within a predefined viewing area of the display device, the predefined viewing area being bounded by a screen size of a screen of the display device.

4. The method of claim 2 wherein the magnifier window is displayed at least partially overlapping the first image.

5. The method of claim 2 wherein the magnifier window is operable to implement all edit commands to the second image which can be implemented on the first image.

6. The method of claim 2 wherein the magnifier window is a first magnifier window, and further comprising displaying a second magnifier window that displays a third image that is a different portion of the first image, the third image having a zoomed-in view that is a closer view of the different portion than in the first image.

7. The method of claim 2 wherein the magnifier window includes a zoom control which receives input to adjust a magnification factor of the second image displayed in the magnifier window.

8. The method of claim 6 wherein the first magnifier window includes a lock control receptive to user input and providing selection between a locked state and an unlocked state, wherein the locked state causes the first and second magnifier windows to be locked at a magnification level of the first magnifier window and non-adjustable by a user, and the unlocked state allows the user to adjust the magnification level of the first magnifier window and the second magnifier window independently.

9. The method of claim 2 wherein the magnifier window includes a pin control receptive to user input and providing selection between a pinned state and an unpinned state, wherein the pinned state prohibits a user from moving the magnifier window on the display device and closing the magnifier window, and wherein the unpinned state allows the user to move and close the magnifier window.

10. The method of claim 2 wherein at least one line is displayed between the magnifier window and the portion of the first image located in the first image, wherein the at least one line indicates the location on the first image of the second image displayed in the magnifier window.

11. The method of claim 10 further comprising receiving input that controls the magnifier window to be moved to a different area of the display device, wherein the line displayed between the magnifier window and the portion of the first image is moved with the magnifier window.

12. The method of claim 4 wherein the magnifier window has a controllable transparency, wherein the transparency allows at least part of the first image to be displayed through the second image in the magnifier window.

13. A computer program product comprising a computer readable medium including program instructions to be implemented by a computer and for displaying a magnified image using a computer system, the program instructions for:
causing a display on a display device of a first image;
causing a display on the display device of a second image that is a portion of the first image, the second image having a zoomed-in view that is a closer view of the portion than in the first image; and
causing at least one edit to the second image in response to at least one input received at the second image.

14. The computer program product of claim 12 wherein the second image is displayed in a magnifier window.

15. The computer program product of claim 14 wherein the magnifier window and the first image are both displayed within a predefined viewing area of the display device, the predefined viewing area being bounded by a screen size of a screen of the display device.

16. The computer program product of claim 14 wherein the magnifier window is operable to implement all edit commands to the second image which can be implemented on the first image.

17. The computer program product of claim 14 wherein the magnifier window is a first magnifier window, and further comprising displaying a second magnifier window that displays a third image that is a different portion of the first image, the third image having a zoomed-in view that is a closer view of the different portion than in the first image.

18. The computer program product of claim 14 wherein the magnifier window includes a zoom control which receives input to adjust a magnification factor of the second image displayed in the magnifier window.

19. The computer program product of claim 14 wherein at least one line is displayed between the magnifier window and the portion of the first image located in the first image, wherein the at least one line indicates the location on the first image of the second image displayed in the magnifier window.

20. A system for displaying a magnified image using a computer system, the system comprising:
a memory; and
a processor in communication with the memory, the processor:
causing a display on a display device of a first image;
causing a display on the display device of a magnifier window including second image that is a portion of the first image, the second image having a zoomed-in view that is a closer view of the portion than the displayed view of the first image; and
causing at least one edit to the second image in response to at least one input received at the second image.

21. The system of claim 20 wherein the magnifier window and the first image are both displayed within a predefined viewing area of the display device, the predefined viewing area being bounded by a screen size of a screen of the display device.

22. The system of claim 20 wherein the magnifier window is operable to implement all edit commands to the second image which can be implemented on the first image.

23. The system of claim 20 wherein the magnifier window includes a zoom control which receives input to adjust a magnification factor of the second image displayed in the magnifier window.
